(19) United States
(12) Patent Application Publication
(10) Pub. No.: US 2019/0252808 A1
(43) Pub. Date: Aug. 15, 2019

(54) TERMINAL BLOCK

(71) Applicant: OMRON Corporation, Kyoto-shi, Kyoto (JP)

(72) Inventors: Keisuke OTAKA, Yokohama-shi (JP); Sadahito OTSU, Kyoto-shi (JP); Naoki UENO, Kyoto-shi (JP); Osamu YOSHITAKE, Kyoto-shi (JP); Takahito MIZUE, Kyoto-shi (JP)

(73) Assignee: OMRON Corporation, Kyoto-shi, Kyoto (JP)

(21) Appl. No.: 16/329,248

(22) PCT Filed: Sep. 26, 2017
(86) PCT No.: PCT/JP2017/034706

§ 371 Date: Feb. 28, 2019

(30) Foreign Application Priority Data
Sep. 30, 2016 (JP) 2016-194248

(51) Int. Cl. H01R 9/24; H01R 4/48

(52) U.S. Cl. CPC H01R 9/2416; H01R 4/48

(57) ABSTRACT

A terminal block includes a housing having an accommodation portion and through holes, a terminal portion disposed in the accommodation portion, and a plate spring portion that, together with the terminal portion, holds a wiring member inserted into the accommodation portion through the through hole. The plate spring portion includes a base portion that constitutes a fixed end of deflection deformation and a front end portion that constitutes a free-end of deflection deformation when the plate spring portion is pressed using a tool inserted into the accommodation portion through the through hole. A protrusion is provided in a portion of a surface of the plate spring portion between the base portion and the front end portion. It is possible to obtain a terminal block capable of inhibiting a tool from coming off from the through hole.

### TECHNICAL FIELD

The present invention relates to a terminal block capable of fixing a wiring member to a terminal portion using a plate spring.

### RELATED ART

As disclosed in JP 2000-048875A (Patent Document 1), a wiring member such as a single wire or a rod terminal is fixed to a terminal portion of a terminal block. A structure for detachably fixing a wiring member to a terminal portion using a plate spring is known as a structure for fixing a wiring member to a terminal portion. Such a terminal block is used in various electronic devices such as a circuit breaker and a PLC (Programmable Logic Controller).

In the terminal block (electrical wire connection device) disclosed in Patent Document 1 above, the plate spring and the terminal portion are disposed to be opposite each other in a housing. The wiring member is inserted between the plate spring and the terminal portion, the wiring member is held between the plate spring and the terminal portion, and thus the wiring member is fixed. When the wiring member is detached therefrom, the wiring member can be pulled out by deforming the plate spring that presses the wiring member against the terminal portion in a direction away from the wiring member (terminal portion).

The wiring member can be easily disposed at a position located between the plate spring and the terminal portion by deforming the plate spring in a direction away from the terminal portion not only in the case where the wiring member is pulled out but also in the case where the wiring member with low rigidity is inserted toward the terminal portion. Examples of methods for deforming the plate spring in a direction away from the terminal portion include a method for deforming the plate spring by pressing the plate spring using a release button, and a method for deforming the plate spring by directly pressing the plate spring using a tool such as a screwdriver.

The release button is disposed adjacent to the plate spring, and the release button is slid using a hand, a finger, or a screwdriver, the plate spring is then pressed by the release button, and thus the plate spring is deformed in a direction away from the terminal portion (wiring member). It is possible to remove or insert the wiring member from/into a position located between the plate spring and the terminal portion in a state in which the plate spring is deformed in a direction away from the terminal portion.

On the other hand, operations of deforming the plate spring using a tool such as a screwdriver are performed as follows. That is, the inner portion of the housing is provided with an accommodation portion, and the terminal portion and the plate spring are disposed in the accommodation portion. The housing is provided with two through holes that are formed side-by-side, extend from a front surface of the housing, to the accommodation portion. A wiring member such as a single wire or a rod terminal is inserted into the housing through one of the two through holes (first through hole), the wiring member is held between the plate spring and the terminal portion, and thus fixed.

A screwdriver (e.g., flathead screwdriver) can be inserted into the other of the two through holes (second through hole), and by directly pressing the plate spring using a front end of the screwdriver, the plate spring is deformed in a direction away from the terminal portion (wiring member). It is possible to remove or insert the wiring member from/into a position located between the plate spring and the terminal portion in a state in which the plate spring is deformed in a direction away from the terminal portion.

### RELATED ART DOCUMENTS

### Patent Documents

Patent Document 1: JP 2000-048875A

### SUMMARY OF THE INVENTION

### Problem to be Solved by the Invention

The plate spring is deformed in a direction away from the terminal portion by inserting a tool such as a screwdriver into the other of the two through holes (second through hole). It is possible to remove or insert the wiring member from/into a position located between the plate spring and the terminal portion in a state in which the plate spring is deformed in a direction away from the terminal portion.

With a conventional terminal block, when a tool such as a screwdriver is inserted into one of the two through holes (second through hole), this tool easily comes off from the second through hole, so that it is necessary for an operator to hold the tool using his/her hand all the time during a wiring operation, and thus the operator cannot easily perform the wiring operation in some cases.

An object of the present invention is to provide a terminal block including a structure that is capable of, when a tool such as a screwdriver is inserted into one of the two through holes (second through hole), further inhibiting the tool from coming off from the second through hole, compared to a conventional structure.

### Means for Solving the Problems

A terminal block based on the present invention includes a housing having a front portion, an accommodation portion located on an inner side when viewed from the front portion, and a first through hole and a second through hole that extend from the front portion to the accommodation portion, a terminal portion disposed in the accommodation portion of the housing, and a plate spring portion that is disposed in the accommodation portion of the housing and, together with the terminal portion, holds a wiring member inserted into the accommodation portion through the first through hole, in which the plate spring portion includes a base portion that constitutes a fixed end of deflection deformation and a front end portion that constitutes a free-end of deflection deformation when the plate spring portion is pressed using a tool inserted into the accommodation portion through the second through hole, the plate spring portion is disposed in the accommodation portion such that the front end portion is located closer to the first through hole than the base portion and the base portion is located closer to the second through hole than the front end portion, and a protrusion that protrudes toward the front portion is provided in a portion of a surface of the plate spring portion between the base portion and the front end portion.

Preferably, in the terminal block, the protrusion extends in the form of a streak in a direction orthogonal to a direction in which the plate spring portion undergoes deflection deformation.

Preferably, in the terminal block, if the first through hole and the second through hole are projected onto the surface of the plate spring portion along an axis of the first through hole in a state in which the wiring member is not inserted into the first through hole and the tool is not inserted into the second through hole, the protrusion is located on the surface of the plate spring portion between an image obtained by projecting the first through hole and an image obtained by projecting the second through hole.

Preferably, in the terminal block, a rib for curbing an amount of deflection deformation of the plate spring portion is provided in the accommodation portion of the housing.

Preferably, in the terminal block, the terminal portion and the plate spring portion are constituted by separate members.

Preferably, in the terminal block, the free-end of the plate spring portion is in contact with the terminal portion in a state in which the wiring member is not inserted into the first through hole and the tool is not inserted into the second through hole.

### Effects of the Invention

According to the above-described configuration, the protrusion provided on the surface of the plate spring portion inhibits a tool such as a screwdriver inserted into one of the two through holes (second through hole) from coming off from the second through hole.

### BRIEF DESCRIPTION OF THE DRAWINGS

FIG. 1 is a perspective view showing a control device 100.

FIG. 2 is a perspective view showing a terminal block 20A.

FIG. 3 is a first perspective view (cross-sectional perspective view) showing the exploded terminal block 20A.

FIG. 4 is a second perspective view (cross-sectional perspective view) showing the exploded terminal block 20A.

FIG. 5 is a cross-sectional perspective view showing the terminal block 20A.

FIG. 6 is a cross-sectional view showing the terminal block 20A.

FIG. 7 is a cross-sectional view illustrating operations performed when a wiring member 11 is fixed to the terminal block 20A.

FIG. 8 is a cross-sectional view showing a situation when a plate spring portion 93 undergoes deflection deformation in a direction away from a terminal portion 72 using a tool 14.

FIG. 9 is an enlarged cross-sectional view showing a region surrounded by a line IX shown in FIG. 8.

FIG. 10 is a cross-sectional view showing a situation when the tool 14 is further inserted toward the back of a through hole 42 from the state shown in FIG. 8 (in which a front end portion 16T of a tapered portion 16 is in contact with a protrusion 94 of a plate spring portion 93).

FIG. 11 is an enlarged cross-sectional view showing a region surrounded by a line XI shown in FIG. 10.

FIG. 12 is a cross-sectional view showing a terminal block 20Z in a comparative example.

FIG. 13 is a perspective view showing a plate spring 90A applied to a terminal block in a first modification of an embodiment.

FIG. 14 is a cross-sectional view showing a plate spring 90B applied to a terminal block in a second modification of an embodiment.

FIG. 15 is a cross-sectional view showing a plate spring 90C applied to a terminal block in a third modification of an embodiment.

### EMBODIMENTS OF THE INVENTION

Hereinafter, an embodiment will be described with reference to the drawings. The same components and equivalent components are given the same reference numerals, and a redundant description is not repeated in some cases.

### Embodiments

### Control Device 100

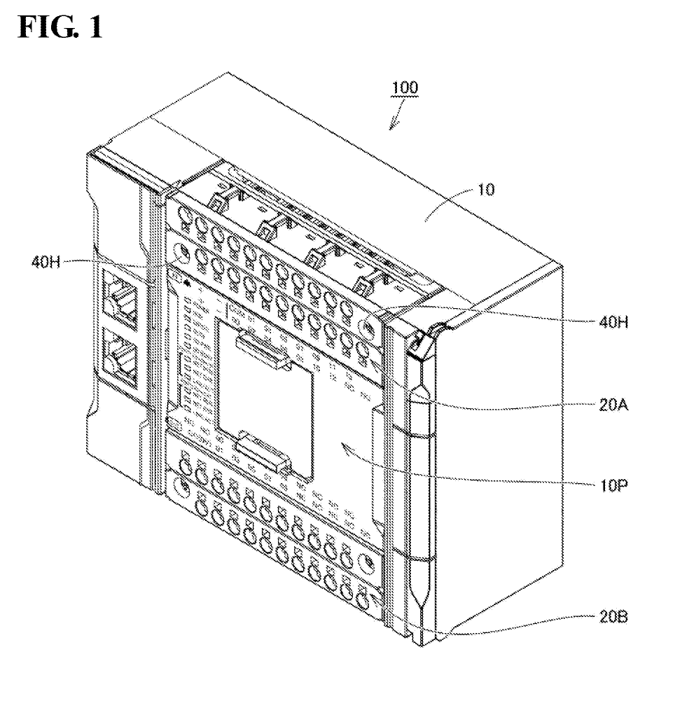

FIG. 1 is a perspective view showing a control device 100. The control device 100 includes a display panel 10P and terminal blocks 20A and 20B on the front side of a main body unit 10, and can function as a PLC (programmable logic controller).

The terminal block 20A may be a means for ensuring electrical connection between the control device 100 and an external device such as a sensor, and a plurality of wiring members (not shown) for transmitting an input signal to the control device 100 are connected to the terminal block 20A. The terminal block 20B may be a means for ensuring electrical connection between the control device 100 and an external device such as a personal computer, and a plurality of wiring members (not shown) for transmitting an output signal are connected to the terminal block 20B.

### Terminal Block 20A

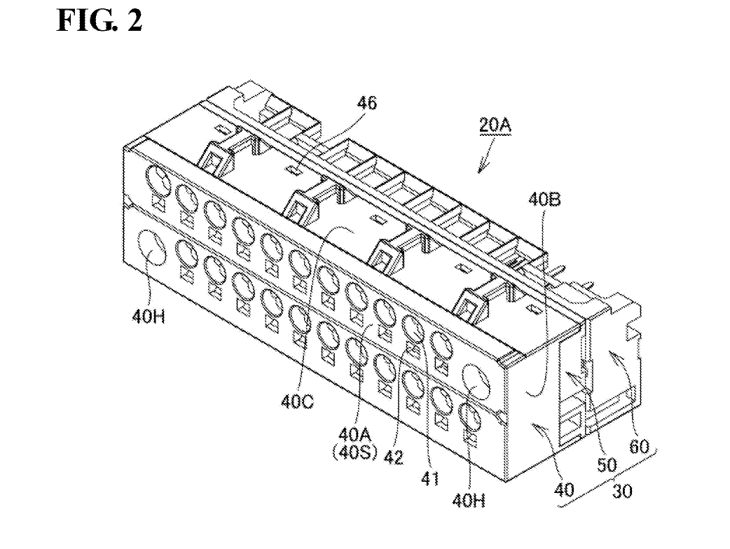

The terminal blocks 20A and 20B have approximately the same configuration, and thus only the terminal block 20A will be described below and a description of the terminal block 20B is not repeated. Specifically, a configuration of the terminal block 20A in this embodiment will be described with reference to FIGS. 2 to 6. Effects of the terminal block 20A will be described later with reference to FIGS. 7 to 11.

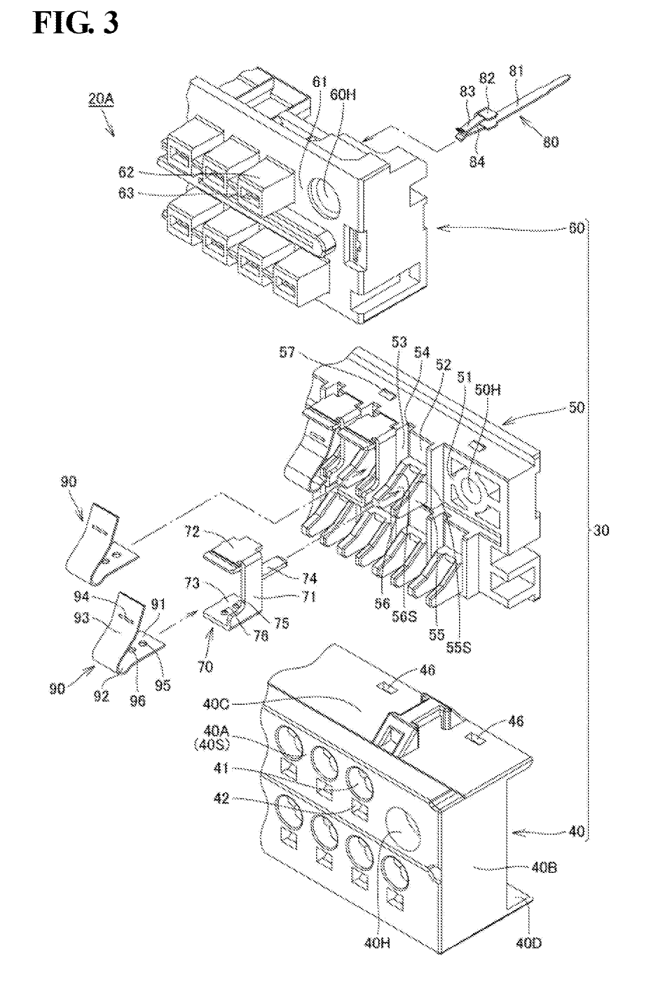

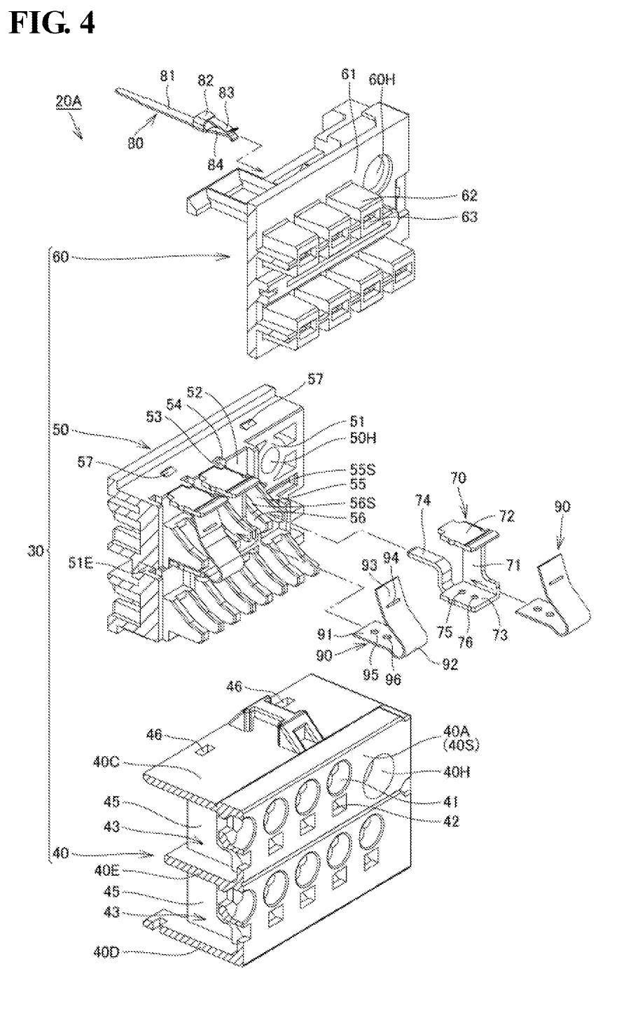

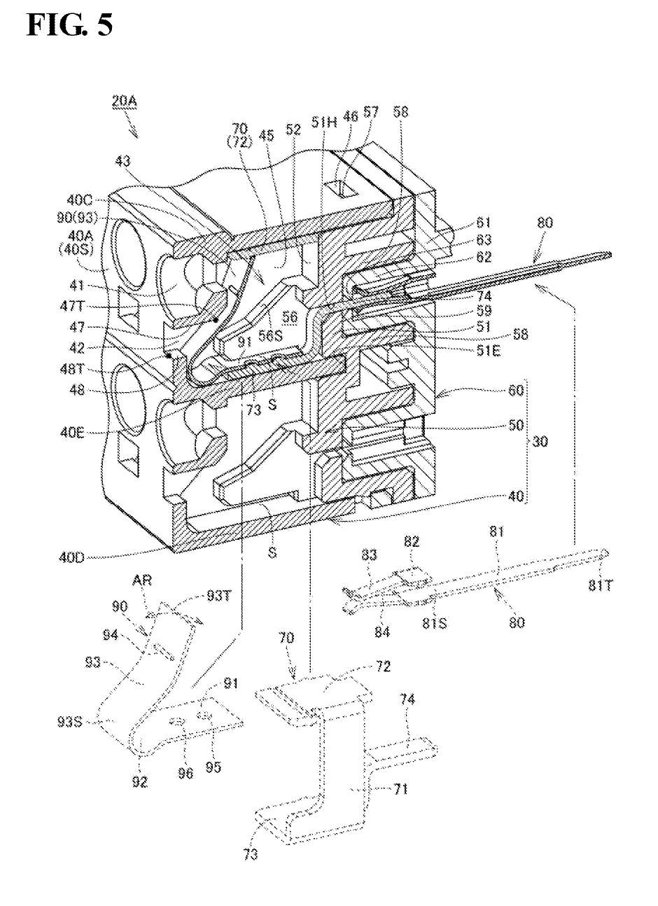

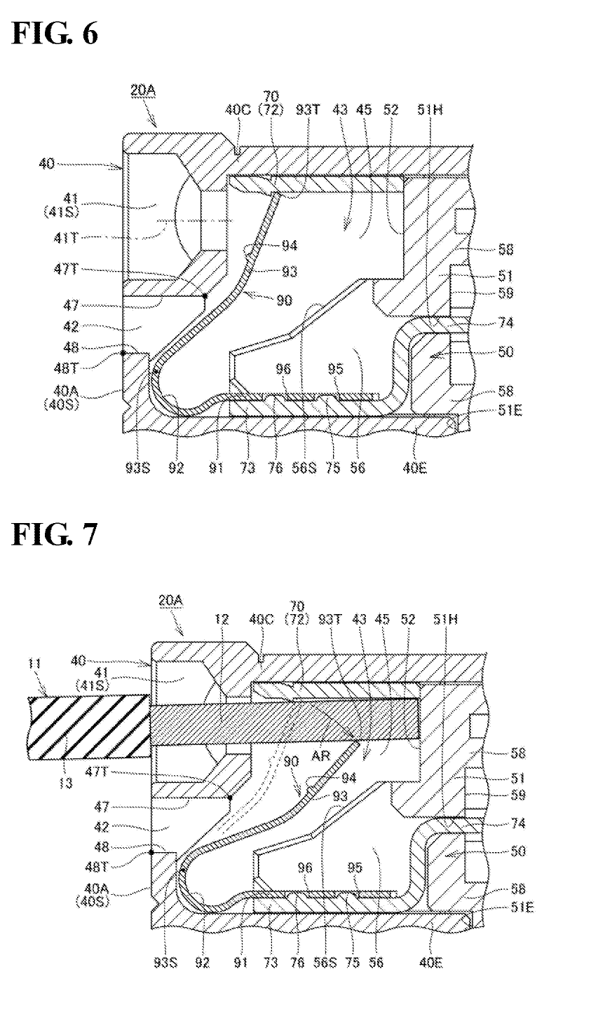

FIG. 2 is a perspective view showing the terminal block 20A. FIGS. 3 and 4 are perspective views (cross-sectional perspective views) showing the exploded terminal block 20A. FIGS. 5 and 6 are respectively a cross-sectional perspective view and a cross-sectional view showing the exploded terminal block 20A. The terminal block 20A includes a housing 30 (FIGS. 2 to 4), a terminal fitting 70 (FIGS. 3 to 5), an electrode member 80 (FIGS. 3 to 5), and a plate spring 90 (FIGS. 3 to 5). The overall shape of the terminal block 20A is substantially cuboidal (see FIG. 2).

### Housing 30

The housing 30 (FIGS. 3 to 5) is constituted by combining a front panel 40, an inner panel 50, and a back panel 60.

### Front Panel 40

As shown in FIGS. 3 to 5, the front panel 40 includes a front portion 40A, side portions 40B (FIGS. 2 and 3), an upper surface portion 40C, a bottom portion 40D, and a middle portion 40E (FIGS. 4 and 5).

The front portion 40A has a plate shape, and constitutes a front surface 40S of the front panel 40. The front portion 40A is provided with a plurality of through holes 41 (first through holes), a plurality of through holes 42 (second through holes), and a pair of openings 40H (FIGS. 1 and 2) that pass through the front portion 40A. Screws (not shown) for fixing the entire terminal block 20A (FIG. 2) to the main body unit 10 of the control device 100 (FIG. 1) are inserted into the openings 40H and 40H.

As shown in FIGS. 1 and 2, the plurality of through holes 41 are formed side-by-side in two rows along a direction parallel to a longitudinal direction of the terminal block 20A. The plurality of through holes 42 are formed side-by-side in two rows along the direction parallel to the longitudinal direction of the terminal block 20A such that the through holes 41 and the through holes 42 have a one-to-one correspondence relation. One of the through holes 42 is always located directly below one of the through holes 41. The plurality of through holes 41 each have a circular shape, and the plurality of through holes 42 each have a rectangular shape.

The upper surface portion 40C, the bottom portion 40D, the middle portion 40E of the front panel 40 each have a plate shape (see FIG. 5), and the upper surface portion 40C, the bottom portion 40D, and the middle portion 40E are disposed in parallel to each other. The upper surface portion 40C extends from an upper end of the front portion 40A toward the back, and the bottom portion 40D extends from a lower end of the front portion 40A toward the back. The middle portion 40E extends from a middle position of the front portion 40A toward the back.

A plurality of partition walls 45 (FIGS. 4 and 5) are provided on the back side of the front portion 40A of the front panel 40. The plurality of partition walls 45 are parallel to the side portions 40B (FIG. 3) of the front panel 40. In other words, the plurality of partition walls 45 are disposed orthogonal to the upper surface portion 40C, the bottom portion 40D, and the middle portion 40E.

The plurality of partition walls 45 are disposed in the longitudinal direction of the terminal block 20A at approximately equal intervals, and define spaces formed between the upper surface portion 40C and the middle portion 40E in a plurality of accommodation portions 43, and define spaces formed between the middle portion 40E and the bottom portion 40D in the plurality of accommodation portions 43.

One of the accommodation portions 43 is defined between a pair of adjacent partition walls 45, the front portion 40A, the upper surface portion 40C, the middle portion 40E, and the inner panel 50 (FIG. 5). Similarly, another accommodation portion 43 is defined between a pair of adjacent partition walls 45, the front portion 40A, the middle portion 40E, the bottom portion 40D, and the inner panel 50 (FIG. 5).

The accommodation portions 43 defined as described above are located inside the housing 30 when viewed from the front portion 40A (see FIG. 2), and one of the through holes 41 and one of the through holes 42 extend from the front portion 40A (front surface 40S) of the front panel 40 to one of the accommodation portions 43 (see FIGS. 4 and 5).

The upper surface portion 40C of the front panel 40 is also provided with a plurality of openings 46 (FIGS. 3 to 5). The openings 46 engage with protrusions 57 (FIGS. 3 to 5) provided in the inner panel 50. When the openings 46 engage with the protrusions 57, the front panel 40 and the inner panel 50 are fixed to each other.

### Inner Panel 50

As shown in FIGS. 3 to 5, the inner panel 50 is a member disposed between the front panel 40 and the back panel 60, and includes a base portion 51, inner wall portions 52, vertical wall portions 53, vertical groove portions 54, ribs 55 and 56, and the protrusions 57.

The base portion 51 extends in a plate shape along the longitudinal direction of the inner panel 50, and openings 50H (FIGS. 3 and 4) are each provided near the two ends in the longitudinal direction of the base portion 51. The openings 40H and 5011 are disposed coaxially with each other in a state in which the front panel 40 and the inner panel 50 are fixed to each other, and screws (not shown) for fixing the entire terminal block 20A (FIG. 2) to the main body unit 10 of the control device 100 (FIG. 1) are inserted into the openings 40H and 50H.

As shown in FIG. 6, the inner wall portion 52 of the inner panel 50 has a flat surface that intersects (herein, is orthogonal to) a direction in which an axis 41T of the through hole 41 (first through hole) extends. That is, the inner wall portion 52 defines one accommodation portion 43 together with a pair of adjacent partition walls 45, the front portion 40A, the upper surface portion 40C, and the middle portion 40E. Similarly, also the other inner wall portions 52 define other accommodation portions 43 together with a pair of adjacent partition walls 45, the front portion 40A, the middle portion 40E, and the bottom portion 40D.

The vertical wall portion 53 (FIGS. 3 and 4) has a plate shape, and extends from the base portion 51 toward the front. The vertical wall portion 53 is orthogonal to the upper surface portion 40C, the bottom portion 40D, and the middle portion 40E of the front panel 40. The vertical groove portion 54 is formed between the inner wall portion 52 and the vertical wall portion 53, and provides a recessed space. The partition walls 45 (see FIG. 4) of the front panel 40 are disposed inside the vertical groove portion 54 in a state in which the front panel 40 and the inner panel 50 are fixed to each other.

The ribs 55 and 56 each have a triangular prismatic shape, and extend from positions of the inner wall portion 52 toward the front. The ribs 55 and 56 are spaced apart from each other at intervals in the longitudinal direction of the base portion 51. Upper surfaces 55S and 56S of the ribs 55 and 56 have an inclined surface shape, and the ribs 55 and 56 are inclined such that upper portions of the upper surfaces 55S and 56S are located on the back side, and lower portions of the upper surfaces 55S and 56S are located on the front side.

Openings 51H (FIGS. 5 and 6) are provided at positions of the base portion 51 located between the ribs 55 and 56 while passing through the base portion 51. Although details will be described later, an L-shaped portion 74 of the terminal fitting 70 is inserted into the opening 51H (FIGS. 5 and 6). The upper portion of the base portion 51 is also provided with a plurality of protrusions 57 (FIGS. 3 to 5). When the openings 46 provided in the upper surface portion 40C of the front panel 40 engage with the protrusions 57 provided in the base portion 51 of the inner panel 50, the front panel 40 and the inner panel 50 are fixed to each other.

As shown in FIG. 5, a recessed portion 51E is provided on the front side of the base portion 51 (see also FIG. 4). The recessed portion 51E extends in the form of a groove along the longitudinal direction of the base portion 51. The recessed portion 51E has a shape corresponding to the front end portion of the middle portion 40E of the front panel 40, and the middle portion 40E of the front panel 40 is disposed inside the recessed portions 51E in a state in which the front panel 40 and the inner panel 50 are fixed to each other (see FIG. 5).

As shown in FIG. 5, a plurality of plate-shaped portions 58 are provided on the back side of the base portion 51, and a recess 59 is formed between adjacent plate-shaped portions 58 and 58. The back panel 60 is provided with protruding portions 62 (FIGS. 3 and 4), and the protruding portions 62 are disposed inside the recesses 59 in a state in which the inner panel 50 and the back panel 60 are fixed to each other (see FIG. 5).

### Back Panel 60

As shown in FIGS. 3 to 5, the back panel 60 is a member that is disposed on the back side of the inner panel 50, and includes a base portion 61, the protruding portions 62, and openings 63.

The base portion 61 extends in a plate shape along the longitudinal direction of the back panel 60, and openings 60H (see FIGS. 3 and 4) are provided near the two ends in the longitudinal direction of the base portion 61. The openings 40H, 50H, and 60H are disposed coaxially with each other in a state in which the front panel 40, the inner panel 50, and the back panel 60 are fixed to each other, and screws (not shown) for fixing the entire terminal block 20A (FIG. 2) to the main body unit 10 of the control device 100 (FIG. 1) are inserted into the openings 40H, 50H, and 60H.

The protruding portions 62 have a substantially cuboidal shape, and extend from the base portion 61 toward the front. The protruding portions 62 have a hollow shape, and a front end portion of the electrode member 80, which will be described later, is disposed inside one of the protruding portions 62 (see FIG. 5). The openings 63 pass through sites of the protruding portions 62 on the front side. Although details will be described later, an L-shaped portion 74 of the terminal fitting 70 is inserted into the opening 63 (see FIG. 5).

### Terminal Fitting 70

As shown in FIGS. 3 to 5, the terminal fitting 70 includes a rising wall portion 71, a terminal portion 72, a base portion 73, and the L-shaped portion 74. The terminal fitting 70 is disposed in the accommodation portion 43 together with the plate spring 90, which will be described later.

The rising wall portion 71, the terminal portion 72, and the base portion 73 each have a substantially flat-plate shape. The terminal portion 72 extends from the upper end of the rising wall portion 71 in a direction that is substantially orthogonal to the rising wall portion 71, and the base portion 73 extends from the lower end of the rising wall portion 71 in a direction that is substantially orthogonal to the rising wall portion 71. The overall shape of the rising wall portion 71, the terminal portion 72, and the base portion 73 resembles a C-shape, and the L-shaped portion 74 extends from the base portion 73 toward the back.

The surface of the base portion 73 is provided with protrusions 75 and 76. Although details will be described later, a base portion 91 of the plate spring 90 is provided with openings 95 and 96 corresponding to the protrusions 75 and 76. When the base portion 91 of the plate spring 90 is placed on the base portion 73 of the terminal fitting 70, the protrusions 75 and 76 are respectively disposed in the openings 95 and 96 (see FIG. 6), and thus the position of the plate spring 90 with respect to the terminal fitting 70 is determined (defined).

The L-shaped portion 74 is connected to a portion of the back side of the base portion 73, extends upward from the portion of the back side of the base portion 73, linearly extends from a front end portion of this extension portion toward the back side, and the overall shape of the L-shaped portion 74 is substantially L-shaped. As described above, the opening 51H is provided at a position located between the ribs 55 and 56 provided on the inner panel 50 while passing through the base portion 51. Furthermore, the protruding portions 62 of the back panel 60 are provided with the openings 63. The L-shaped portion 74 of the terminal fitting 70 is inserted into the openings 51H and 63 (see FIG. 5).

### Electrode Member 80

As shown in FIGS. 3 to 5, the electrode member 80 includes a flat-plate portion 81, a U-shaped portion 82, and a pair of holding pieces 83 and 84, and its overall shape is substantially a rod shape.

The flat-plate portion 81 extends linearly, and one end 81T (FIG. 5) of the flat-plate portion 81 is electrically connected to a control board disposed in the main body unit 10 of the control device 100 (FIG. 1). The U-shaped portion 82 is provided at the other end 81S of the flat-plate portion 81. The pair of holding pieces 83 and 84 are provided opposite the flat-plate portion 81 with respect to the U-shaped portion 82.

As described above, the back panel 60 is provided with the protruding portions 62. The U-shaped portion 82 and the holding pieces 83 and 84 of the electrode member 80 are disposed inside the protruding portion 62 (see FIG. 5). The L-shaped portion 74 of the terminal fitting 70 is inserted in the openings 51H and 63, and when the holding pieces 83 and 84 of the electrode member 80 hold the L-shaped portion 74 of the terminal fitting 70, the terminal fitting 70 and the electrode member 80 are electrically connected to each other.

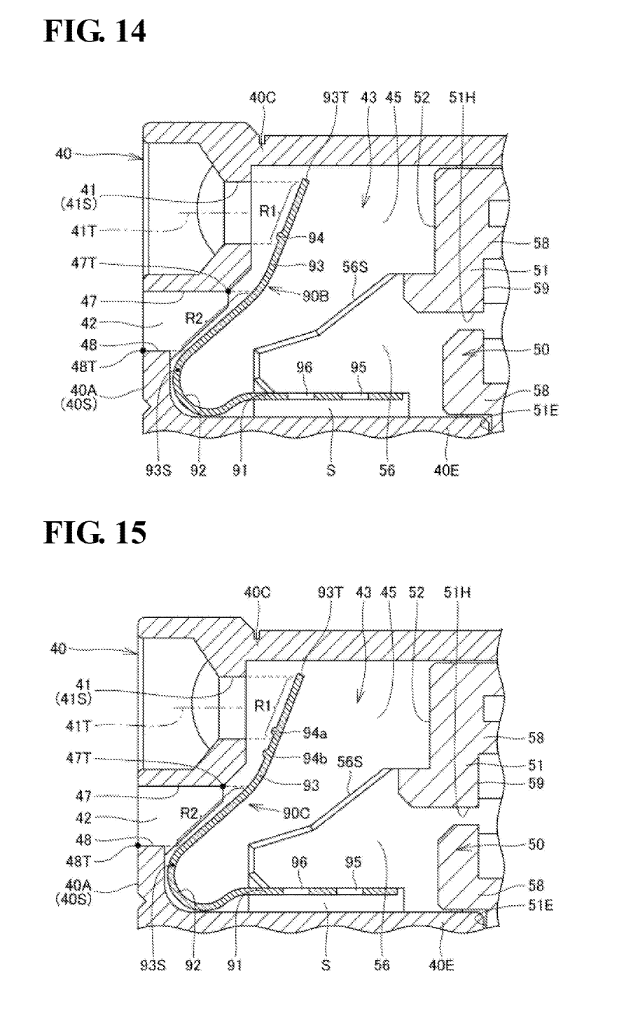

Referring to FIGS. 5 and 6, as described above, the accommodation portions 43 are defined between the front panel 40 and the inner panel 50 (between the upper surface portion 40C and the middle portion 40E) in a state in which the front panel 40 is fixed to the inner panel 50. In this state, a gap S is formed between the lower surface of the rib 56 (and the lower surface of the rib 55 (not shown)) and the upper surface of the middle portion 40E (see FIGS. 5 and 14).

In a state in which the members are assembled together as the terminal block 20A (in the state of the completed terminal block 20A), the base portion 73 of the terminal fitting 70 is disposed inside the gap S (for convenience of the description, the terminal fitting 70 is not shown in FIG. 14). Furthermore, the terminal portion 72 of the terminal fitting 70 faces the lower surface of the upper surface portion 40C (see FIGS. 5 and 6). The same applies to the accommodation portions 43 defined between the middle portion 40E and the bottom portion 40D and the terminal fittings 70 disposed in these accommodation portions 43.

### Plate Spring 90

As shown in FIGS. 3 to 5, the plate spring 90 includes the base portion 91, a curved portion 92, and a plate spring portion 93. The plate spring 90 is disposed in the accommodation portion 43 together with the terminal fitting 70.

The base portion 91 and the plate spring portion 93 each have a substantially flat-plate shape, and the curved portion 92 is provided between the base portion 91 and the plate spring portion 93. As described above, the base portion 91 of the plate spring 90 is provided with the openings 95 and 96 corresponding to the protrusions 75 and 76 of the terminal fitting 70. When the base portion 91 of the plate spring 90 is placed on the base portion 73 of the terminal fitting 70, the protrusions 75 and 76 are respectively disposed in the openings 95 and 96 (see FIG. 6), and thus the position of the plate spring 90 with respect to the terminal fitting 70 is determined (defined).

The accommodation portions 43 are defined between the front panel 40 and the inner panel 50 (between the upper surface portion 40C and the middle portion 40E) in a state in which the front panel 40 is fixed to the inner panel 50. In this state, a gap S is formed between the lower surface of the rib 56 (and the lower surface of the rib 55 (not shown)) and the upper surface of the middle portion 40E (see FIGS. 5 and 14). The base portion 91 of the plate spring 90 is disposed inside the gap S together with the base portion 73 of the terminal fitting 70.

The curved portion 92 is substantially C-shaped in a cross-sectional view, and is connected to an end of the base portion 91 on the front side. The plate spring portion 93 is connected to the upper end of the curved portion 92. The plate spring portion 93 is inclined such that the upper portion of the plate spring portion 93 is located on the back side, and the lower portion of the plate spring portion 93 is located on the front side. One end of the plate spring portion 93 is supported by the curved portion 92, and the plate spring portion 93 can undergo deflection deformation like a plate spring.

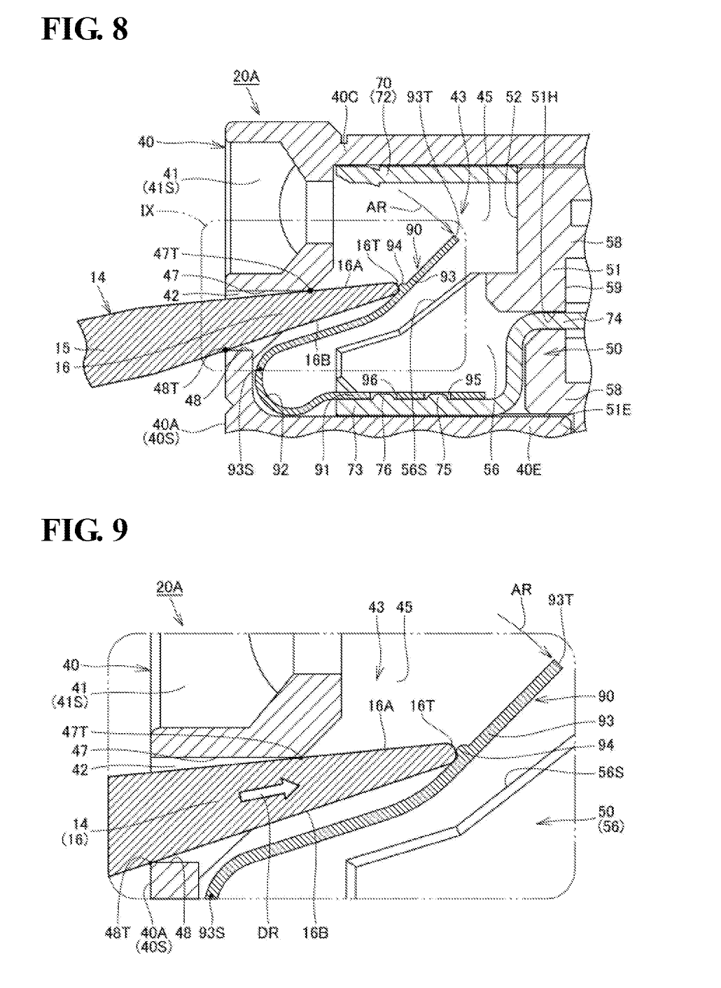

For example, when the plate spring portion 93 is pressed by the wiring member 11 (see the wiring member 11 in FIG. 7) inserted into the accommodation portion 43 through the through hole 41 (first through hole), the plate spring portion 93 undergoes deflection deformation. Alternatively, when the plate spring portion 93 is pressed by a tool (see the tool 14 in FIG. 8) inserted into the accommodation portion 43 through the through hole 42 (second through hole), the plate spring portion 93 undergoes deflection deformation.

The plate spring portion 93 includes a base portion 93S (FIG. 6) that forms a fixed end of deflection deformation, and a front end portion 93T (FIG. 6) that forms a free-end of deflection deformation. The plate spring portion 93 is disposed in the accommodation portion 43 such that the front end portion 93T is located closer to the through hole 41 (first through hole) than the base portion 93S, and the base portion 93S is located closer to the through hole 42 (second through hole) than the front end portion 93T.

The plate spring portion 93 is spaced apart from and faces the upper surface 55S and 56S of the ribs 55 and 56 in a state in which the plate spring 90 is disposed in the accommodation portion 43 (see FIG. 6). The ribs 55 and 56 (upper surfaces 55S and 56S) provided in the accommodation portion 43 can curb an amount of deflection deformation (the maximum deflection deformation amount) of the plate spring portion 93 of the plate spring 90.

The front end portion 93T of the plate spring portion 93 faces the terminal portion 72 of the terminal fitting 70, and is capable of holding, together with the terminal portion 72, the wiring member (see the wiring member 11 in FIG. 7) inserted into the accommodation portion 43 through the through hole 41 (see FIG. 7). In the present embodiment, the front end portion 93T of the plate spring portion 93 is in contact with the terminal portion 72 of the terminal fitting 70 in a state in which the wiring member 11 (FIG. 7) is not inserted into the through hole 41 and the tool 14 (FIG. 8) is not inserted in the through hole 42, that is, in the natural state of the plate spring 90 (see FIG. 6).

In the present embodiment, a member (the terminal fitting 70) that constitutes the terminal portion 72 and a member (the plate spring 90) that constitutes the plate spring portion 93 are constituted by separate members, and are disposed in the accommodation portion 43 in a state in which these members are assembled with each other. The present invention is not limited to such a configuration, and the member that constitutes the terminal portion 72 and the member that constitutes the plate spring portion 93 may also be constituted by a single member.

Herein, a portion of the surface of the plate spring portion 93 between the base portion 93S and the front end portion 93T is provided with a protrusion 94 that protrudes toward the front portion 40A of the front panel 40. The surface of the protrusion 94 has a semicircular shape or a polygonal shape in a cross-sectional view, for example.

When the plate spring 90 is produced through press-molding, the protrusion 94 may be easily formed on the plate spring portion 93 through press-molding, for example. The protrusion 94 in the present embodiment extends in the form of a streak in a direction orthogonal to a direction in which the plate spring portion 93 undergoes deflection deformation (see arrow AR in FIG. 5).

### Effects

Referring to FIG. 7, the wiring member 11 such as a single wire or a rod terminal is fixed to the terminal block 20A, the wiring member 11 is inserted into the through hole 41 at the position located between the plate spring portion 93 of the plate spring 90 and the terminal portion 72 of the terminal fitting 70. The wiring member 11 is inserted until coming into contact with the inner wall portion 52 while subjecting the plate spring portion 93 to deflection deformation in a direction indicated by the arrow AR.

The wiring member 11 has an electrode portion 12 and a covered portion 13, and when the electrode portion 12 is held between the plate spring portion 93 of the plate spring 90 and the terminal portion 72 of the terminal fitting 70, the wiring member 11 is fixed. The wiring member 11 is pressed against the terminal portion 72 of the terminal fitting 70 by an elastic restoring force of the plate spring 90 (the plate spring portion 93), and thus the wiring member 11 is electrically connected to the terminal fitting 70.

When the wiring member 11 is removed, the wiring member 11 can be pulled out by subjecting the plate spring portion 93 that presses the wiring member 11 against the terminal portion 72 to undergo deflection deformation in a direction away from the wiring member 11 (the terminal portion 72). It is possible to easily dispose the wiring member 11 at the position located between the plate spring portion 93 and the terminal portion 72 by subjecting the plate spring portion 93 to undergo deflection deformation in a direction away from the terminal portion 72 not only in the case where the wiring member 11 is pulled out but also in the case where the wiring member 11 with low rigidity is inserted toward the terminal portion 72. Hereinafter, this operation will be described in detail.

### Tool 14

FIG. 8 is a cross-sectional view showing a situation when the plate spring portion 93 undergoes deflection deformation in a direction away from the terminal portion 72 using the tool 14. FIG. 9 is an enlarged cross-sectional view showing a region surrounded by a line IX shown in FIG. 8. Referring to FIGS. 8 and 9, the tool 14 is typically a flathead screwdriver, and has a cylindrical portion 15 and a tapered portion 16.

The tool 14 can be inserted into the through hole 42 (second through hole). By directly pressing the plate spring portion 93 of the plate spring 90 using a front end portion 16T of the tool 14, the plate spring portion 93 undergoes deflection deformation in a direction away from the terminal portion 72 or the wiring member 11 (not shown).

Specifically, the tool 14 is inserted into the through hole 42 as shown in arrow DR shown in FIG. 9. At this time, the front end portion 16T of the tool 14 slides against the surface of the plate spring portion 93. When the tool 14 is inserted into the through hole 42, the plate spring portion 93 is subjected to a pressing force from the tool 14 and undergoes deflection deformation in the direction (the direction away from the terminal portion 72 and the wiring member 11) indicated by the arrow AR.

An inner circumferential surface of the housing 30 (the front panel 40) that forms the through hole 42 has an upper surface portion 47 and a lower surface portion 48. A corner 47T is formed at a position on the rearmost side of the upper surface portion 47, and a corner 48T is formed at a position on the frontmost side of the lower surface portion 48. When the tool 14 is inserted into the through hole 42, the upper surface portion 47 and the corner 47T slide against an upper surface 16A of the tapered portion 16 of the tool 14, and the lower surface portion 48 and the corner 48T slide against a lower surface 16B of the tapered portion 16 of the tool 14.

The tool 14 is inserted toward the back of the through hole 42 while being guided due to the surfaces of the tapered portion 16 sliding against these corners. The tool 14 is inserted until the front end portion 16T of the tapered portion 16 comes into contact with the protrusion 94 of the plate spring portion 93. FIGS. 8 and 9 show a situation where the front end portion 16T is in contact with the protrusion 94. When the front end portion 16T of the tapered portion 16 comes into contact with the protrusion 94 of the plate spring portion 93, an operator recognizes a click feel from the terminal block 20A through the tool 14 (a flathead screwdriver).

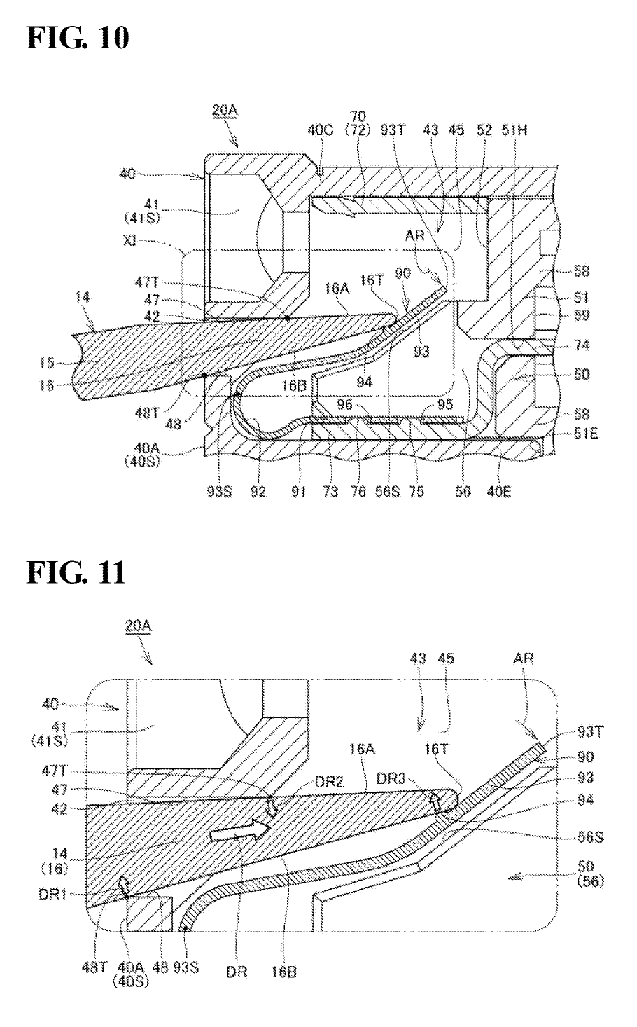

FIG. 10 is a cross-sectional view showing a situation when the tool 14 is further inserted toward the back of the through hole 42 from the state shown in FIG. 8 (the state in which the front end portion 16T of the tapered portion 16 is in contact with the protrusion 94 of the plate spring portion 93). FIG. 11 is an enlarged cross-sectional view showing a region surrounded by a line XI shown in FIG. 10.

The tool 14 is further inserted toward the back of the through hole 42 by the operator as indicated by the arrow DR shown in FIG. 9. Along with this, the front end portion 16T of the tapered portion 16 moves over the protrusion 94 of the plate spring portion 93, the plate spring portion 93 is subjected to a pressing force from the tool 14, and further undergoes deflection deformation in the direction indicated by the arrow AR (the direction away from the terminal portion 72 and the wiring member 11).

After the tool 14 is inserted toward the back of the through hole 42 to a certain depth, the tool 14 stops moving. The upper surface 56S of the rib 56 and the upper surface 55S of the rib 55 (not shown) are present on the back side of the plate spring portion 93. The tool 14 may also be inserted toward the back of the through hole 42 until the plate spring portion 93 comes into contact with the ribs 55 and 56 (upper surfaces 55S and 56S). The ribs 55 and 56 prevent the tool 14 from being excessively (unnecessarily) pushed.

Referring to FIG. 11, the tool 14 (tapered portion 16) is subjected to a pressing force (arrow DR3) caused by an elastic restoring force of the plate spring portion 93 from the protrusion 94 in a state in which the tool 14 is inserted toward the back of the through hole 42 to a certain depth and the tool 14 stops moving. The pressing force indicated by the arrow DR3 acts on the lower surface 16B of the tapered portion 16.

The tapered portion 16 is pressed against the upper surface portion 47 that forms the through hole 42 in the front portion 40A, and its repulsive force acts on the upper surface 16A of the tapered portion 16 (arrow DR2). This repulsive force acts on the upper surface 16A of the tapered portion 16 from the corner 47T of the upper surface portion 47 in the present embodiment, but may also act on the upper surface 16A of the tapered portion 16 from the upper surface portion 47 (a flat portion) of the front panel 40 in a direction that is substantially the same as the arrow DR2.

A force for rotating the tool 14 in a counterclockwise direction about the corner 47T acts on the tool 14 (tapered portion 16) by the pressing forces indicated by the arrows DR2 and DR3, and its repulsive force acts on the lower surface 16B of the tapered portion 16 (arrow DR1). This repulsive force acts on the lower surface 16B of the tapered portion 16 from the corner 48T of the lower surface portion 48 in the present embodiment, but may also act on the lower surface 16B of the tapered portion 16 from the lower surface portion 48 (a flat portion) of the front panel 40 in a direction that is substantially the same as the arrow DR1.

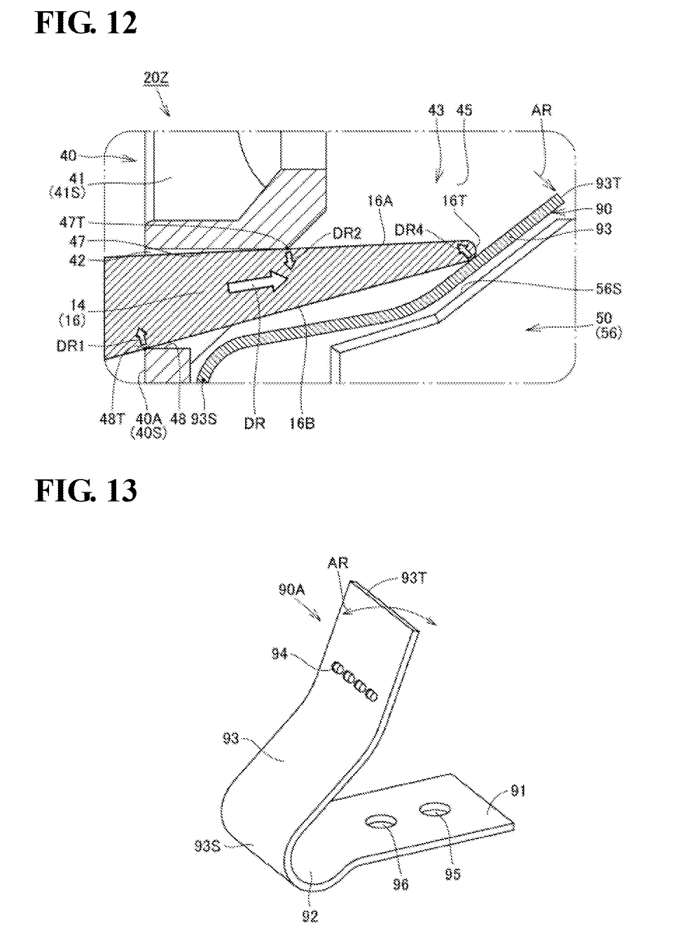

That is, the tool 14 inserted into the through hole 42 is subjected to pressing forces indicated by the arrows DR1, DR2, and DR3 from the front panel 40 and the plate spring 90 (protrusion 94) that constitutes the terminal block 20A. Out of these pressing forces, the pressing force indicated by the arrow DR3 acts in a direction that is substantially orthogonal to the arrow DR (the direction in which the tool 14 is removed from and inserted into the through hole 42). The functional effects obtained from this technical idea will be described in comparison with a comparative example shown in FIG. 12.

### COMPARATIVE EXAMPLE

In a terminal block 20Z shown in FIG. 12, the surface of a plate spring portion 93 is not provide with a protrusion 94. Similarly to the above-described embodiment, it is presumed that a tool 14 is inserted into a through hole 42.

With the terminal block 20Z, a pressing force (arrow DR4) acts on a front end portion 16T of a tapered portion 16 in a direction that is substantially orthogonal to the surface of the plate spring portion 93, instead of the pressing force indicated by the arrow DR3 (FIG. 11). When the arrow DR3 and the arrow DR4 are compared with each other, the arrow DR3 acts in a direction that is substantially orthogonal to the arrow DR (the direction in which the tool 14 is removed from and inserted into the through hole 42).

On the other hand, the arrow DR4 acts in a direction that intersects the arrow DR (the direction in which the tool 14 is removed from and inserted into the through hole 42) at an acute angle. That is, the pressing force indicated by the arrow DR4 includes a force component that acts in a direction in which the tool 14 is separated from the through hole 42 (the direction that is opposite to the direction indicated by the arrow DR) to a larger extent than the pressing force indicated by the arrow DR3.

Thus, with the terminal block 20Z, when a tool 14 such as a flathead screwdriver is inserted into the through hole 42, the tool 14 easily comes off from the through hole 42, and it is necessary for the operator to hold the tool 14 with his/her hand all the time during a wiring operation, and thus the operator cannot easily perform a wiring operation.

In contrast, in the above-described embodiment (see FIG. 11), the pressing force indicated by the arrow DR3 includes a force component that acts in a direction in which the tool 14 is separated from the through hole 42 (the direction that is opposite to the direction indicated by the arrow DR) to a smaller extent than the pressing force indicated by the arrow DR4. Thus, with the terminal block 20A, when the tool 14 such as a flathead screwdriver is inserted into the through hole 42, the tool 14 is unlikely to come off from the through hole 42, and it is not necessary for the operator to hold the tool 14 with his/her hand during a wiring operation, and thus the operator can easily perform a wiring operation.

In the above-described embodiment, when the tool 14 such as a flathead screwdriver is inserted into the through hole 42, the front end portion 16T of the tapered portion 16 comes into contact with the protrusion 94 of the plate spring portion 93. At this time, an operator recognizes a click feel from the terminal block 20A (protrusion 94) through the tool 14 (flathead screwdriver).

The operator feels to further insert the tool 14 using a weak force after recognizing a click feel, and thus can predict, in advance, an approximate state in which the tool 14 is inserted, and it is also possible to inhibit the tool 14 from being excessively (unnecessarily) pushed. From the viewpoint of realization of such idea that is based on human engineering, the terminal block 20A of the embodiment is more advantageous than the terminal block 20Z of the comparative example.

### First Modification

FIG. 13 is a perspective view showing a plate spring 90A applied to a terminal block in a first modification of an embodiment. The protrusion 94 of the plate spring 90 in the above-described embodiment extends in the form of a streak in a direction orthogonal to a direction in which the plate spring portion 93 undergoes deflection deformation (see the arrow AR in FIG. 5).

Referring to FIG. 13, a plurality of protrusions 94 are provided on the plate spring portion 93 of the plate spring 90A. The plurality of protrusions 94 in the present modification are linearly arranged side-by-side at intervals in a direction orthogonal to a direction in which the plate spring portion 93 undergoes deflection deformation (see the arrow AR in FIG. 13). With this configuration, it is also possible to obtain effects that are similar to those of the above-described embodiment.

### Second Modification

FIG. 14 is a cross-sectional view showing a plate spring 90B applied to a terminal block in a second modification of an embodiment.

In the above-described embodiment, if through holes 41 and 42 are projected onto the surface of a plate spring 90 along an axis 41T of the through hole 41 in a state in which the wiring member 11 is not inserted into the through hole 41 and the tool 14 is not inserted into the through hole 42, that is, in the natural state of the plate spring 90, the protrusion 94 is located on a surface of the plate spring portion 93 between an image R1 obtained by projecting the through hole 41 (see FIG. 14) and an image R2 obtained by projecting the through hole 42 (see FIG. 14) (see FIG. 6).

Referring to FIG. 14, if the through holes 41 and 42 are projected onto the surface of the plate spring portion 93 along the axis 41T of the through hole 41 in a state in which the wiring member 11 is not inserted into the through hole 41 and the tool 14 is not inserted into the through hole 42, that is, in the natural state of the plate spring 90, the protrusion 94 may be located on the surface of the plate spring portion 93 while overlapping with the image R1 obtained by projecting the through hole 41 (see FIG. 14). Alternatively, the protrusion 94 may also be located on the surface of the plate spring portion 93 while overlapping with the image R2 obtained by projecting the through hole 42 (see FIG. 14).

The position of the protrusion 94 may be set to the optimal position at which the tool 14 is more unlikely to come off, according to the size and shape of the accommodation portion 43, the plate spring portion 93 and the like that constitute the terminal block, or according to the size and shape (determined according to the size of the through hole 42, for example) of the tool 14 assumed to be used.

### Third Modification

FIG. 15 is a cross-sectional view showing a plate spring 90C applied to a terminal block in a third modification of an embodiment.

One protrusion 94 is provided on the surface of the plate spring portion 93 in the longitudinal direction of the plate spring portion 93 in the above-described embodiment. As shown in FIG. 15, a plurality of protrusions 94a and 94b may also be provided on the surface of the plate spring portion 93 according to the size and shape of the accommodation portion 43, the plate spring portion 93, and the like that constitute the terminal block, or according to the size and shape (determined according to the size of the through hole 42, for example) of the tool 14 assumed to be used. The positions and the number of protrusions 94a and the positions and the number of protrusions 94b may be set to the optimal values such that the tool 14 is more unlikely to come off.

Although an embodiment was described above, the content disclosed above is to be considered exemplary in all respects and in no way limiting. The technical scope of the present invention is indicated by the scope of the claims, and all changes that come within the meaning and range of equivalency of the claims are intended to be embraced therein.

### INDEX TO THE REFERENCE NUMERALS

10 Main body unit
10P Display panel
11 Wiring member
12 Electrode portion
13 Covered portion
14 Tool
15 Cylindrical portion
16 Tapered portion
16A, 55S, 56S Upper surface
16B Lower surface
16T, 93T Front end portion
20A, 20B, 20Z Terminal block
30 Housing
40 Front panel
40A Front portion
40B Side portion
40C, 47 Upper surface portion
40D Bottom portion
40E Middle portion
40H, 46, 50H, 51H, 60H, 63, 95, 96 Opening
40S Front surface
41, 42 Through hole
41T Axis
43 Accommodation portion
45 Partition wall
47T, 48T Corner
48 Lower surface portion
50 Inner panel
51, 61 Base portion
51E Recessed portion
52 Inner wall portion
53 Vertical wall portion
54 Vertical groove portion
55, 56 Rib
57, 75, 76 Protrusion
58 Plate-shaped portion
59 Recess
60 Back panel
62 Protruding portion
70 Terminal fitting
71 Rising wall portion
72 Terminal portion
73 Base portion
74 L-shaped portion
80 Electrode member
81 Flat-plate portion
81S Another end
81T One end
82 U-shaped portion
83, 84 Holding piece
90, 90A Plate spring
91 Base portion
92 Curved portion
93 Plate spring portion
93S Base portion
94, 94a, 94b Protrusion
100 Control device
AR, DR, DR1, DR2, DR3, DR4 Arrow
R1, R2 Projected image
S Gap

1. A terminal block comprising:
a housing including a front portion, an accommodation portion located on an inner side when viewed from the front portion, and a first through hole and a second through hole that extend from the front portion to the accommodation portion;
a terminal portion disposed in the accommodation portion of the housing; and
a plate spring portion that is disposed in the accommodation portion of the housing and, together with the terminal portion, holds a wiring member inserted into the accommodation portion through the first through hole,
wherein the plate spring portion includes a base portion that constitutes a fixed end of deflection deformation and a front end portion that constitutes a free-end of deflection deformation when the plate spring portion is pressed using a tool inserted into the accommodation portion through the second through hole,
the plate spring portion is disposed in the accommodation portion such that the front end portion is located closer to the first through hole than the base portion and the base portion is located closer to the second through hole than the front end portion,
a protrusion that protrudes toward the front portion is provided in a portion of a surface of the plate spring portion between the base portion and the front end portion, an inner circumferential surface of the housing that forms the second through hole has an upper surface portion and a lower surface portion,
when the tool inserted into the accommodation portion through the second through hole moves over the protrusion, the plate spring portion is pressed by the tool and undergoes deflection deformation, and
the upper surface portion, the lower surface portion, and the protrusion apply pressing force to the tool that has moved over the protrusion.

2. The terminal block according to claim 1,
wherein the protrusion extends in the form of a streak in a direction orthogonal to a direction in which the plate spring portion undergoes deflection deformation.

3. The terminal block according to claim 1,
wherein, if the first through hole and the second through hole are projected onto the surface of the plate spring portion along an axis of the first through hole in a state in which the wiring member is not inserted into the first through hole and the tool is not inserted into the second through hole, the protrusion is located on the surface of the plate spring portion between an image obtained by projecting the first through hole and an image obtained by projecting the second through hole.

4. The terminal block according to claim 1,
wherein a rib for curbing an amount of deflection deformation of the plate spring portion is provided in the accommodation portion of the housing.

5. The terminal block according to claim 1,
wherein the terminal portion and the plate spring portion are constituted by separate members.

6. The terminal block according to claim 1,
wherein the free-end of the plate spring portion is in contact with the terminal portion in a state in which the wiring member is not inserted into the first through hole and the tool is not inserted into the second through hole.
